(19) United States
(12) Patent Application Publication
(10) Pub. No.: US 2013/0054406 A1
(43) Pub. Date: Feb. 28, 2013

(54) METHOD OF SENDING MEMORABILIA CONTAINING TEXT MESSAGES

(71) Applicant: Gary Ritts, Reseda, CA (US)

(72) Inventor: Gary Ritts, Reseda, CA (US)

(21) Appl. No.: 13/217,529

(22) Filed: Aug. 25, 2011

(51) Int. Cl. G06Q 30/00

(52) U.S. Cl. 705/26.5

(57) ABSTRACT

A method for inscribing a communicated text message as a memorabilia on a wearable medium utilizing a mobile device is installed with a mobile application. The application allows a user to login to an account using an email id and password. The application is operable to convert the text message into a memorabilia. The user is able to select at least one text message for inscribing on a wearable medium. A snapshot option allows the user to capture an image of a text message for making a memorable moment. The user is permitted to crop and resize the selected image for making the image suitable for inscribing. The user selects at least one of a list of available wearable medium. The user sends the selected image with selected wearable medium to the service provider. The service provider mails the wearable medium to the user.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a method employed in a mobile device and more particularly to a business method for inscribing a communicated text message on a wearable medium utilizing a mobile device.

Mobile devices offer a wide variety of applications for the users to perform online transactions, shopping, online auctions, creating and displaying messages with emoticons. and the like. Applications capable to attach favorite animated characters with short message service are also available.

One prior art described in U.S. Pat. No. 7,756,536 issued to Camp on Jul. 13, 2010 defines a device and method of creating and displaying a short message service (SMS) message capable of attaching and displaying animated characteristics. To create an animated SMS message the user responds to input prompts asking for a mobile identification number that identifies the receiving party, an animation flag that determines whether the SMS message will have animation characteristics, a content pointer location that specifies the location of a content file resident on the receiving device, and the actual text of the SMS message. To display an animated SMS message the receiving device parses the SMS message to determine how to apply the desired animation characteristics. An animation flag is checked and the location of a content file on the receiving device is determined. The content file is retrieved and combined with the text of the SMS message and the combination is then animated according to the animation type specified.

Another prior art, described in U.S. Pat. No 20040162877 published to Van Dok on Aug. 19, 2004, describes various mechanisms that enhance flexibility for the type of content that may be included in a real-time message. It includes enhanced control over the presentation of the real-time message and facilitates the sending and receiving of real-time or instant messages. The present invention allows the sending of real-time messages between contacts using a markup language. Real-time messages are formatted, at least in part, according to a markup language that may enhance the presentation and information communicated in real-time messages. The users are allowed to select personalized fonts and font colors, and other rich formatting capabilities are present. Also the types of information included in a message can be expanded, such as corrections to previous messages, data files, image files, user-defined emoticons. and multimedia files. Such formatting facilitates presenting the various types of content that may be included in a real-time message in line with the real-time message's text.

Another prior art taught in U.S. Pat. No. 7,337,130 issued to Ito on Feb. 26, 2008 describes a personalized product producing system that enables customers to order a personalized product, such as a name card, a stamp, or a sticker/label, inexpensively and conveniently. Customers operate their own cellular phones to send personalized information to be engraved in a stamp or printed on a name card or sticker/label in the form of e-mail to a host computer. The host computer edits the information and sends personalized product producing data to a stamp personalized product producing device. The personalized product producing device produces a personalized product based on the received data.

All of the methods discussed above have considerable drawbacks for providing a communicated text message as wearable memorabilia as all the methods discussed above lack the application to convert a text message to wearable memorabilia utilizing a mobile device.

Therefore, there is a need for a reliable application that can be applied to any mobile device for inscribing a communicated text message on wearable medium. Such a needed method along with the application would inscribe a communicated text message on a wearable medium. The present invention accomplishes these objectives.

### SUMMARY

The present invention is a method for inscribing a communicated text message as a memorabilia on a wearable medium utilizing a mobile device adaptable with a mobile application. Mobile devices may include Blackberry, Android, i Phone, i Pad, windows, tablets and iOS platforms. By selecting the application, a user is able to initiate a process and move from a home page to an application login page. The application login page is configured to enter an e-mail id and a password allowing the user to login. The mobile application is capable to convert the telephonic text message into a wearable memorabilia. The user is provided an option for reset, i.e., to change and confirm a new password. The user can enter the email id and password to login to a user account. The user is able to select at least one text messages for inscribing on a wearable medium. Mode of inscribing a communicated text message as the wearable memorabilia may include etching, printing. stamping. and engraving. A snapshot option is provided for the user to capture an image of a text message for making a memorable moment. The user is permitted to crop and resize the selected image for making the image suitable for inscribing. The user confirms the selection and modification and selects the at least one from the list of available wearable mediums. The list of wearable medium may include T-shirts necklaces and bracelets. The wearable medium can be selected based on the color, size, style and the like depending on the services offered by the affiliate service provider. The user sends the selected image with wearable medium to the service provider. The service provider mails the wearable medium to the user. The payment for inscribing may be made through mobile bill or by other commonly used means, such as a credit card, charge card, debit card, or paypal. There is an option for saved items section so that the user can email or save the details of the order for later reference.

The second embodiment of the present invention is a method for inscribing a communicated text message as a memorabilia on a wearable medium utilizing a mobile device adaptable with a mobile application employing a secret pin number in accordance with one aspect of a preferred embodiment of the present invention. The mobile devices may include Blackberry, Android, i Phone, i Pad, tablets windows and iOS platform devices. A user initiates a process by clicking on an application and moves from a home page into an application login page. The application login page is configured to enter an e-mail id and a password and on clicking a login button, the user is allowed to login. The user can create a new account utilizing a create an account button. The user is able to enter the name, address, cell number and credit card number for activating the user account. When the account is activated the user receives a secret pin number. The user is able to select a desired message from the available message option. The message option may include creating a message, retrieving a message from inbox and retrieving a message from outbox. The user creates a new message and sends the message to a service provider. After receiving the message from the user, the service provider creates a file of the received message and matches the created file with existing user account using mobile number as a validation point. The service provider sends a verification message to the user and requests the user to confirm the order and to send the user's secret pin number. The user sends the secret pin number to the service provider. After accepting the pin number the service provider sends another verification message to the user requesting the user to select at least one wearable medium. The user can select the wearable medium utilizing a click here button. The list of wearable medium may include T-Shirt, necklace and bracelets. The user can selects the desired color, size and style for the wearable medium. Finally the user selects the ok button to confirm the selection. A message indicating the wearable medium selected by the user with color and size is displayed in the mobile device. The user can press ok button to send the message to the service provider and cancel button to cancel the message. A final verification message from the service provider confirming the final selection and delivery of the wearable medium is send to the user. The messaging service may be Short Message Service (SMS) and/or Multimedia Messaging Service (MMS).

### BRIEF DESCRIPTION OF THE FIGURES

FIGS. 1A through 1F show various steps involved in selecting a desired communicated text message for inscribing as a memorabilia on a wearable medium utilizing a mobile device.

FIG. 2 is an operational flow chart illustrating a business method for inscribing the communicated text message as the wearable memorabilia utilizing the mobile device.

FIG. 3A through 3N show various steps involved in selecting a desired communicated text message for inscribing as a memorabilia on a wearable medium utilizing a mobile device employing a secret pin number in accordance with one aspect of another embodiment of the present invention.

FIG. 4 is an operational flow chart illustrating a business method for inscribing the communicated text message as the wearable memorabilia utilizing the mobile device employing a secret pin number in accordance with one aspect of another embodiment of the present invention.

### REFERENCE NUMERALS

10 . . . Various steps involved in selecting a desired communicated text message
12 . . . Application
14 . . . Home page
16 . . . Application login page
18 . . . E-mail id
20 . . . Password
22 . . . Login
24 . . . Reset
26 . . . Selected message
28 . . . Crop option
30 . . . Confirmation
32 . . . Snapshot
34 . . . T-shirt
36 . . . Necklace
38 . . . Bracelet
40 . . . Color
42 . . . Size
44 . . . Style
50 . . . Operational Flow chart illustrating a business method for inscribing the communicated text message as the wearable memorabilia
52 . . . User is provided with a mobile device
54 . . . User is able to access the mobile application utilizing the mobile device
56 . . . User authenticates the mobile application
58 . . . User sets up an account for sharing information with other users
60 . . . User logs into the account by entering an e-mail id and password
62 . . . User selects the text message to be inscribed
64 . . . User captures an image of the text message for making a memorable item
66 . . . User modifies and resizes the image of the selected text
68 . . . User confirms the selection and modification
70 . . . User selects the at least one wearable medium for purchase
72 . . . User selects a color, size, and style for the wearable medium
74 . . . User sends the selected image and details to a service provider
76 . . . Service provider mails the memorabilia on the wearable medium to the user
100 . . . Various steps involved in selecting a desired communicated text message employing a secret pin number
102 . . . Application
104 . . . Home page
106 . . . Application login page
108 . . . E-mail id
110 . . . Password
112 . . . Login
114 . . . Create an account
116 . . . Name
118 . . . Address
120 . . . Cell number
122 . . . Credit card number
124 . . . Activate my account
126 . . . List of received messages
128 . . . New message option
130 . . . Service provider
132 . . . Creating a new message
134 . . . Send button
136 . . . Verification message from the service provider
138 . . . Secret pin number
140 . . . Another verification message from the service provider
142 . . . Click here button
144 . . . T-shirt
146 . . . Necklace
148 . . . Bracelet
150 . . . Color
152 . . . Size
154 . . . Style
156 . . . Ok button
158 . . . Cancel button
160 . . . Final verification message from the service provider
200 . . . Operational Flow chart illustrating a business method for inscribing the communicated text message as the wearable memorabilia employing a secret pin number
202 . . . User is provided with a mobile device
204 . . . User sets up a user account utilizing a mobile application
206 . . . User gets a secret pin number when the account gets activated
208 . . . User selects a message option from the mobile device
210 . . . User selects a message from the message option for inscribing
212 . . . Sending an order for the selected message to the service provider
214 . . . Receiving the selected message and creating a file referring to the received message by the service provider
216 . . . Matching the created file with the existing user account utilizing cell number as a validation point
218 . . . Sending a verification message to the user ensuring a receipt of the message
220 . . . Requesting the user to confirm the selection by reviewing the order and entering a secret pin number
222 . . . Entering the secret pin number and confirming the selection by the user
224 . . . Sending the confirmation message to the service provider
226 . . . Sending another verification message to the user for selecting at least one wearable medium
228 . . . Selecting the at least one wearable medium by choosing a color, size and style for sending the order to the service provider
230 . . . Receiving the order from the user
232 . . . Sending the order to a manufacturing partner by the service provider
234 . . . Sending a final verification message to the user for confirming the placement of order
236 . . . Receiving the wearable memorabilia to the user through a mail

### DETAILED DESCRIPTION

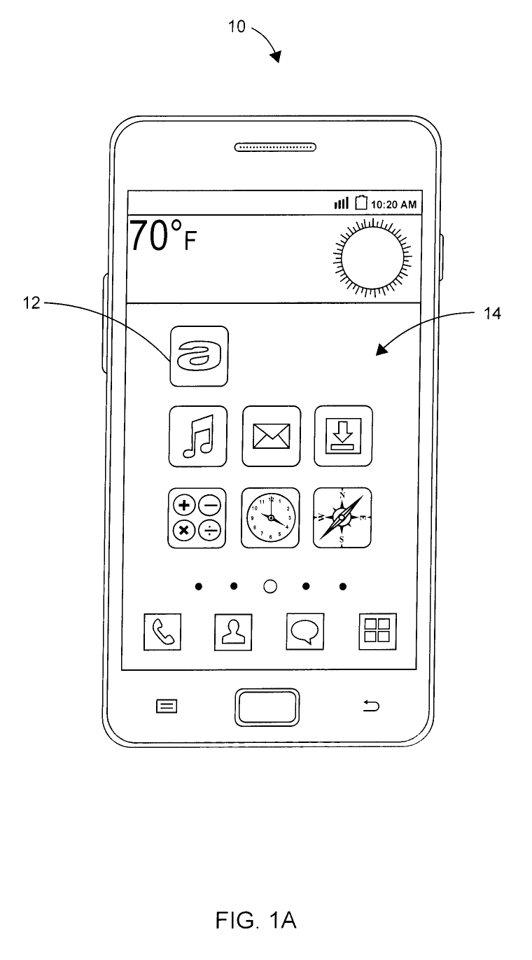

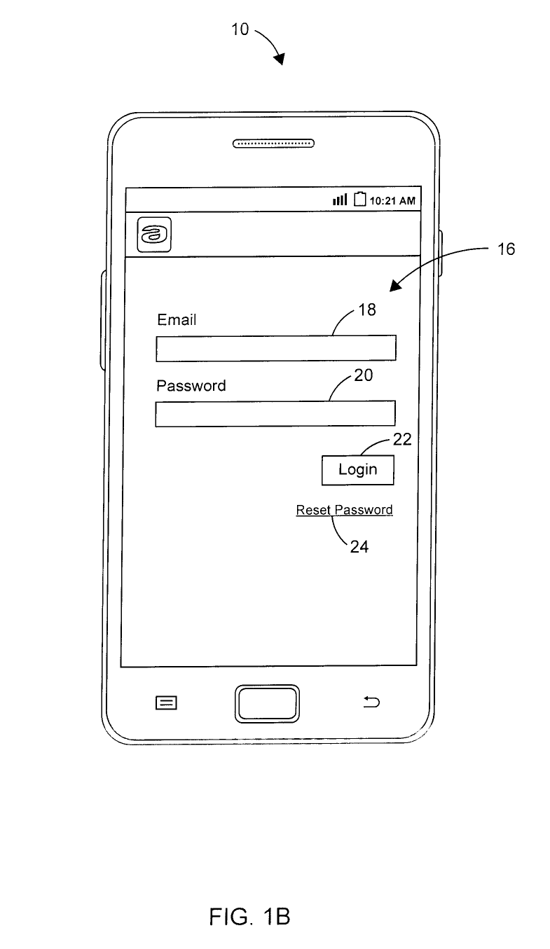

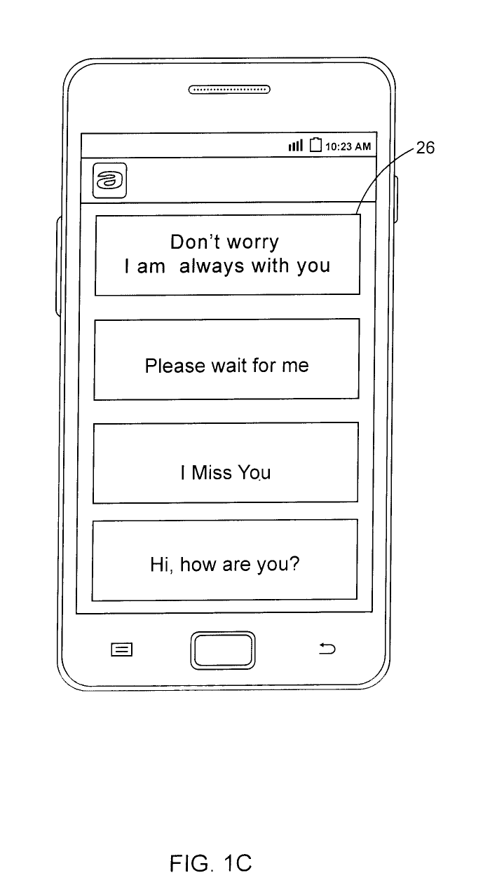

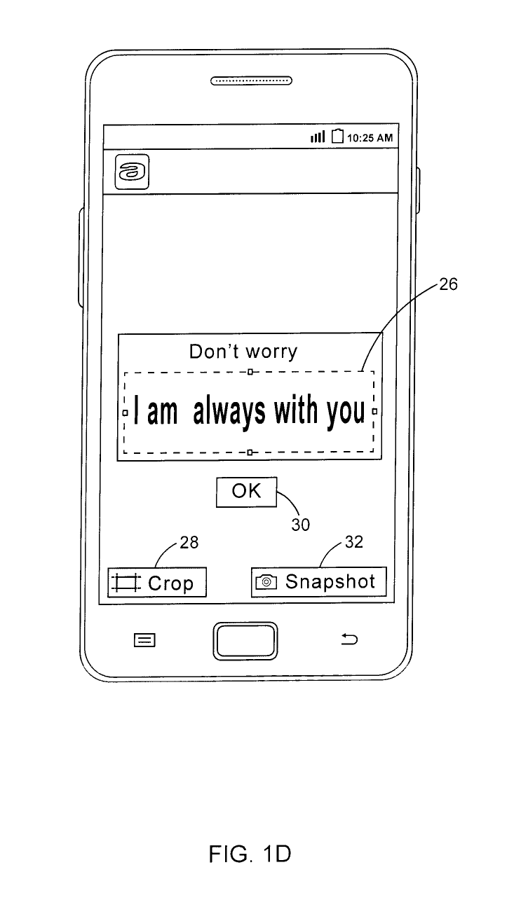

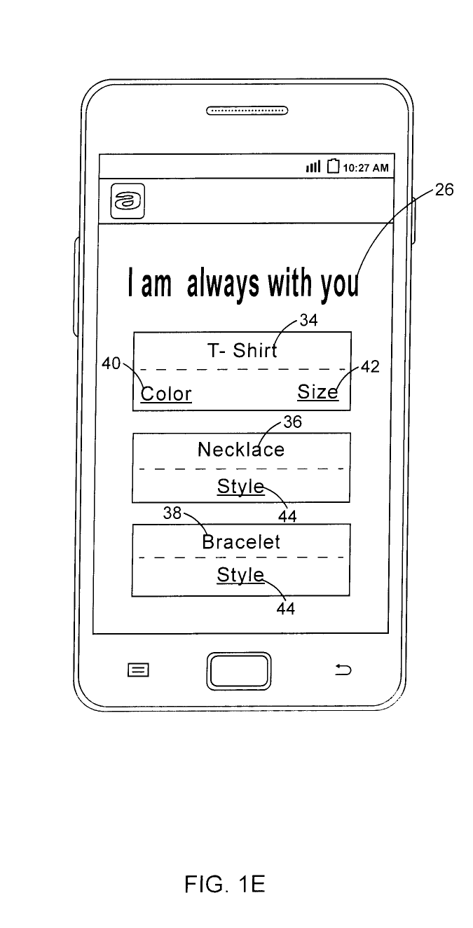

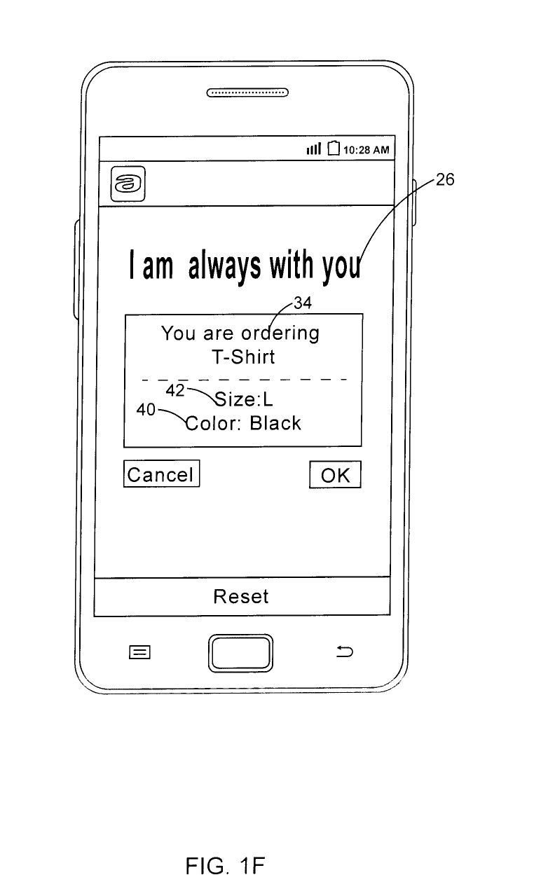

FIGS. 1A through 1F show various steps 10 involved in selecting a desired text message for inscribing on a wearable medium utilizing a mobile device. The mobile devices may include Blackberry, Android, i Phone, i Pad, tablets windows and iOS platform devices. As shown in FIG. 1A, a user initiates a process by clicking on an application 12 and moves from a home page 14 into an application login page 16 as shown in FIG. 1B. The application login page 16 is configured to enter an e-mail id 18 and a password 20 and on clicking a login button 22, the user is allowed to login. The mobile application is capable of converting at least one telephonic text message into a memorabilia. An option for reset 24 is also provided for the user to create and confirm a new password. The user can enter the email id 18 and password 20 to login to user account. FIG. 10 represents a list of text messages and the user is able to select a desired message for inscribing on a wearable medium. Inscribing a communicated text message as a wearable memorabilia may include etching, printing and engraving. The user chooses the selected message 26 for inscribing. FIG. 1D shows a crop option 28 utilized for cropping and resizing the selected message 26. The user confirms the selection and modification 30. A snapshot option 32 is provided for the user to capture an image of a text message for making a memorable moment. FIG. 1E shows the selected image 26 in the cropped and resized format after the confirmation of modification. User selects at least one wearable medium from the list of available wearable medium. The list of wearable medium may include T-shirts 34, necklaces 36 and bracelets 38. The wearable medium can be selected based on the color 40, size 42, style 44 and the like depending on the services offered by the affiliate service provider. FIG. 1F shows an instance of the selected image 26 with selected wearable medium as T-shirt 34 with black as selected color 40 and L as selected size 42. The user sends the image 26 with selected wearable medium 34 to the service provider for inscribing.

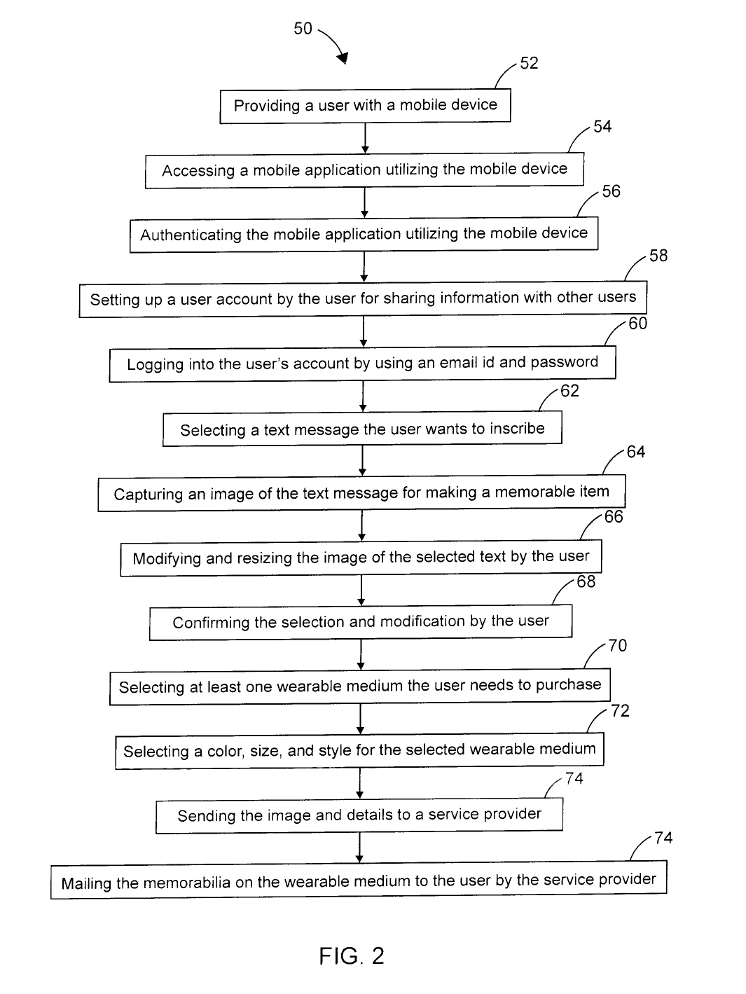

FIG. 2 is a flow chart illustrating a business method for inscribing the communicated text message as the wearable memorabilia utilizing a mobile device 50. As shown in block 52, the user is provided with a mobile device. The user is able to access a mobile application utilizing the mobile device as shown in block 54. Then the user authenticates the mobile application as shown in block 56. As shown in block 58 the user sets up an account for sharing information with other users. The user can log into the account by using an e-mail id and password as shown in block 60. As shown in block 62 the user selects the text message to be inscribed. The user captures an image of the text message for making a memorable item as shown by block 64. The user modifies and resizes the image of the selected text as shown by block 66. Then the user confirms the selection and modification as shown in block 68. The user selects the wearable medium for purchase as shown in block 70 and choose details such as a color, size, and style for the selected wearable medium as shown in block 72. Then the user sends the selected image and details to a service provider as shown in block 74. The service provider mails the memorabilia on the wearable medium to the user as shown in block 76. The modes of payment for inscribing may be through a mobile bill, or by other commercially known methods of payments, e.g., credit card, debit card, paypal.

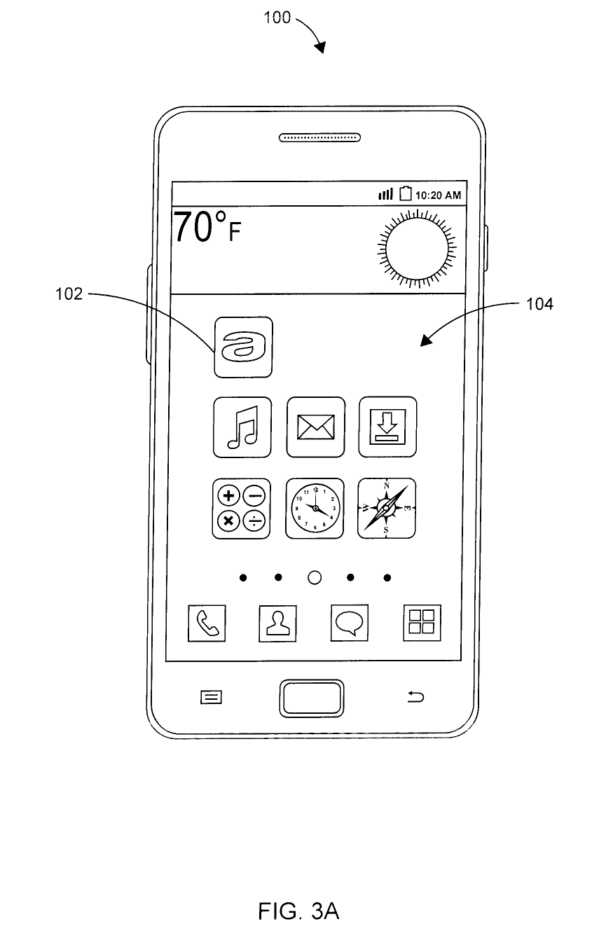

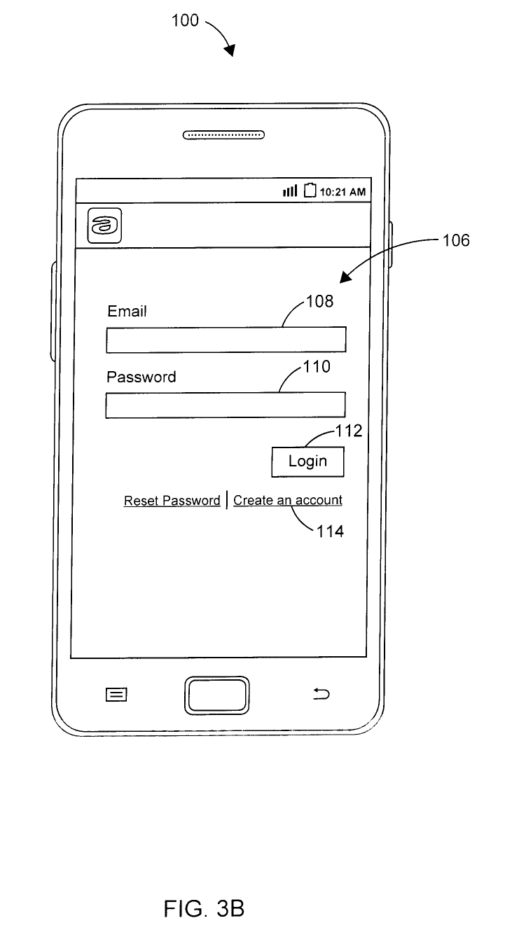

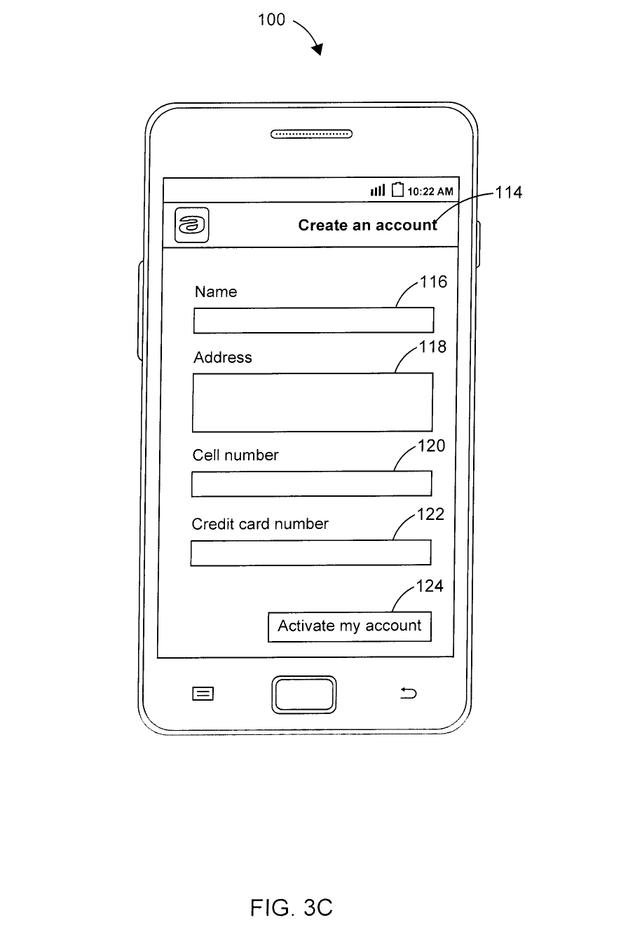

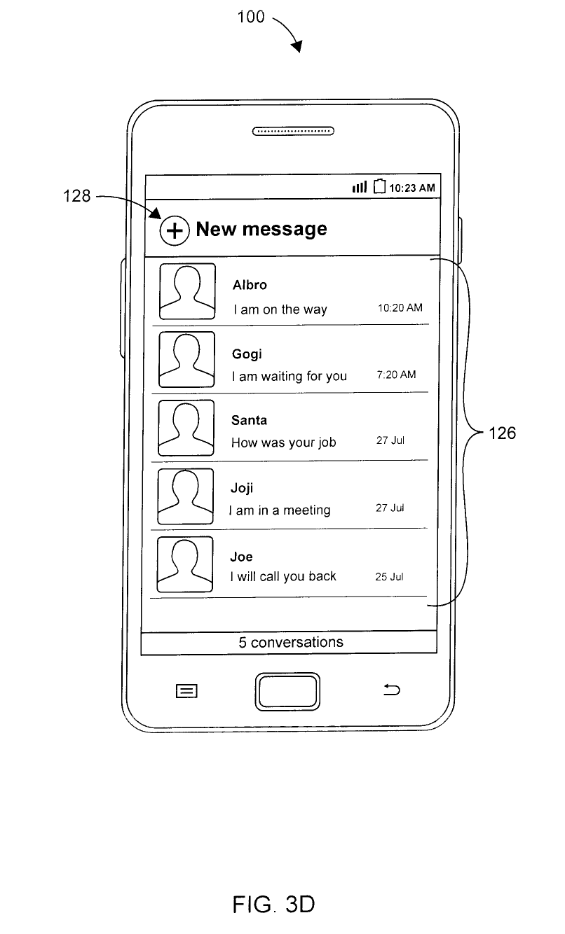

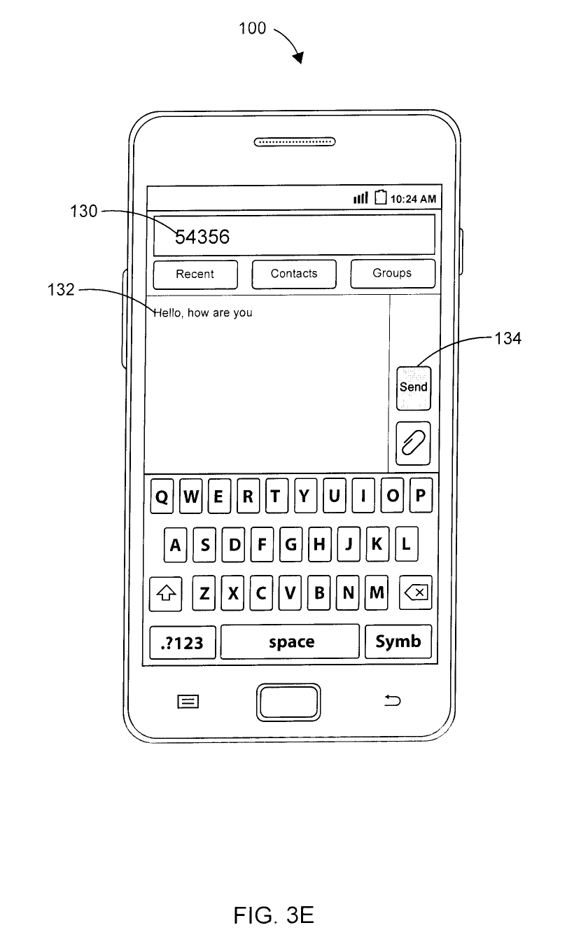

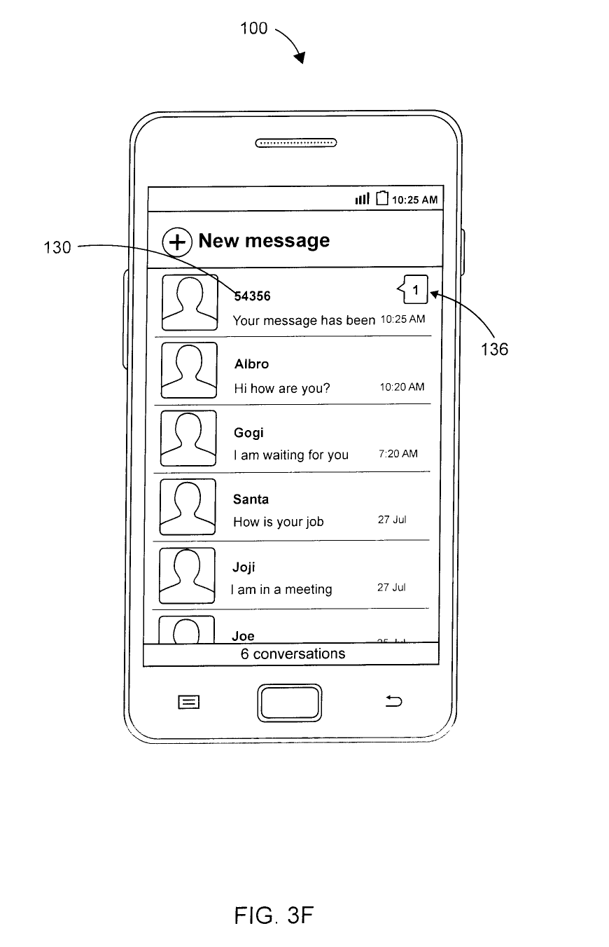

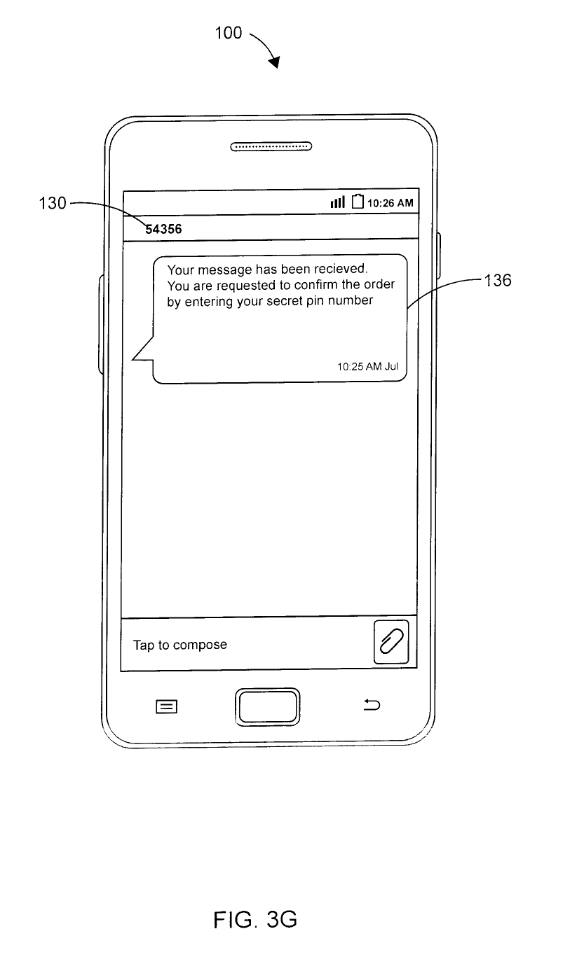

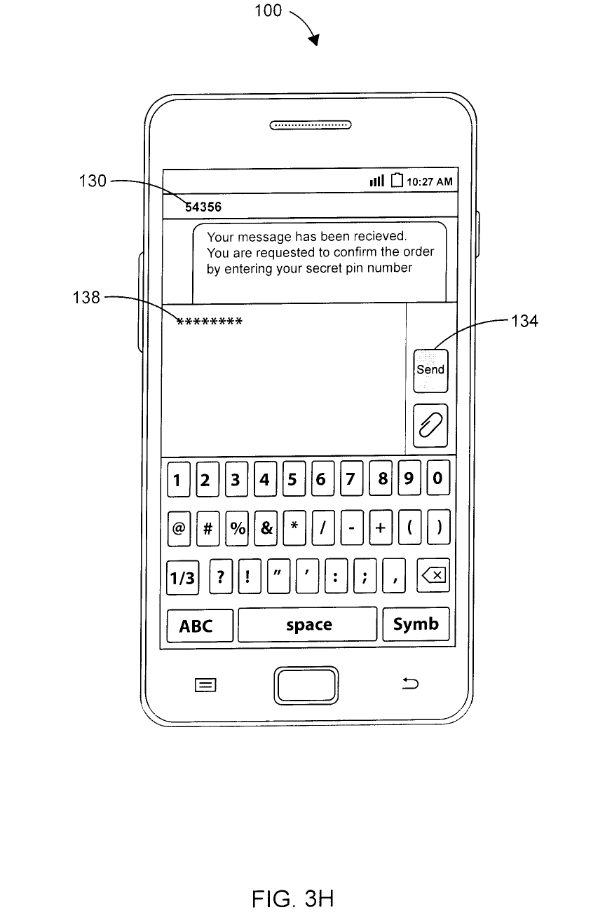

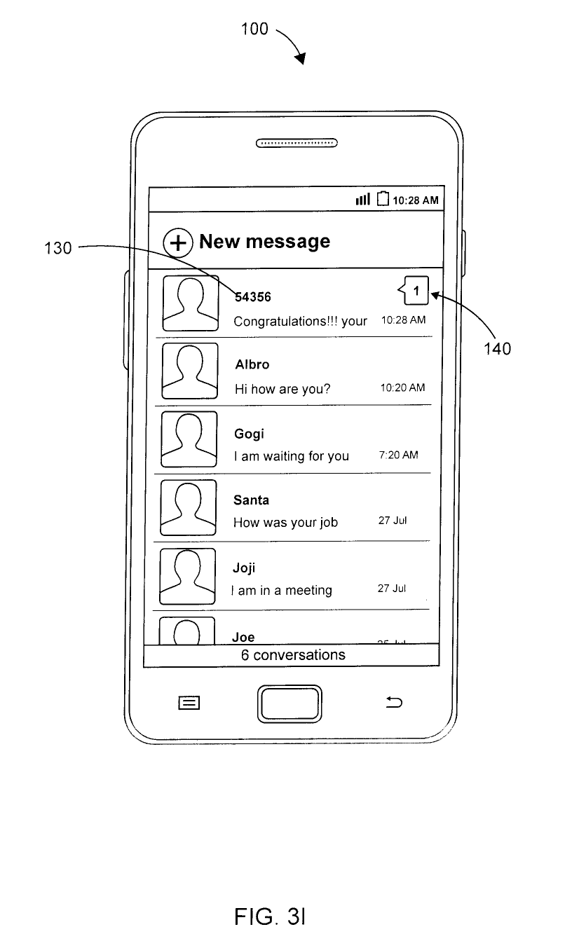

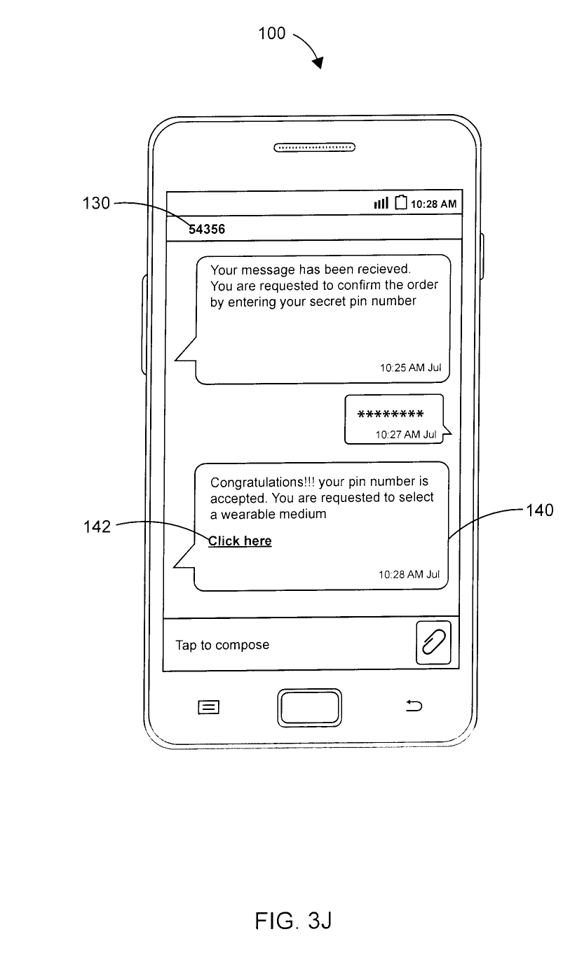

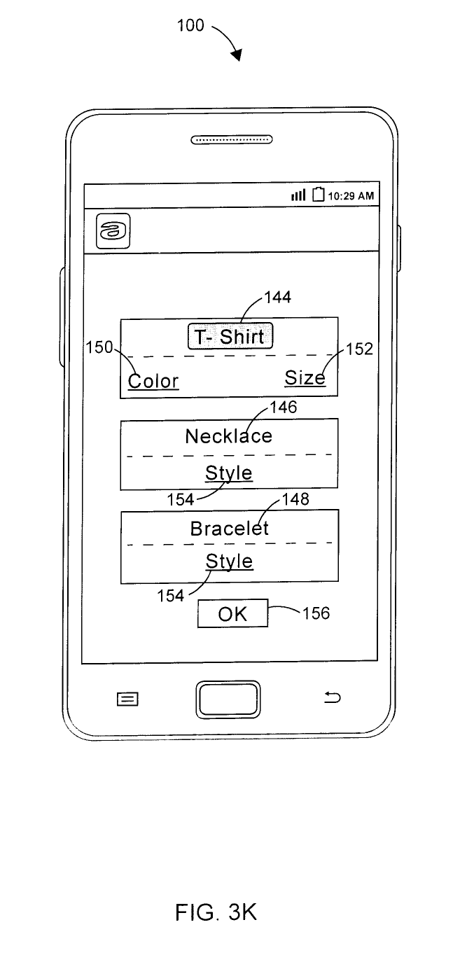

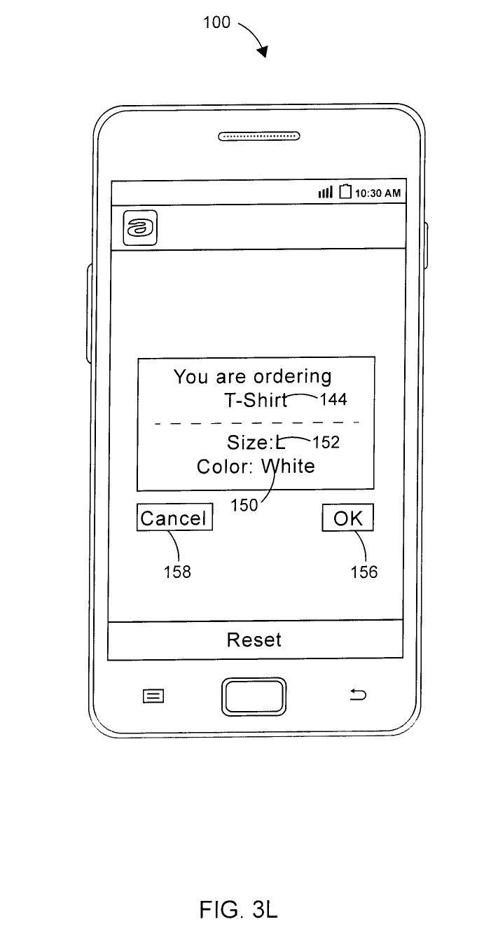

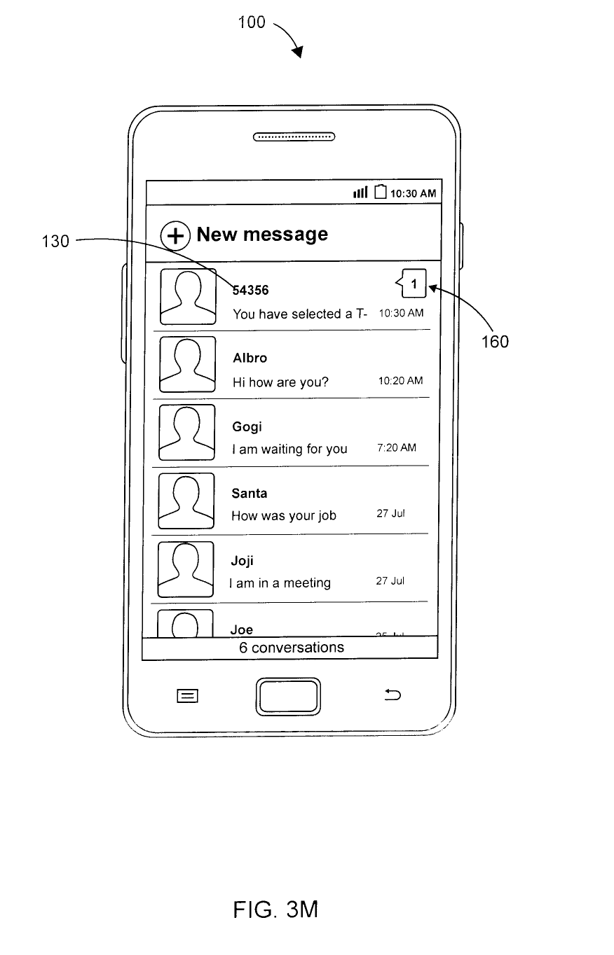

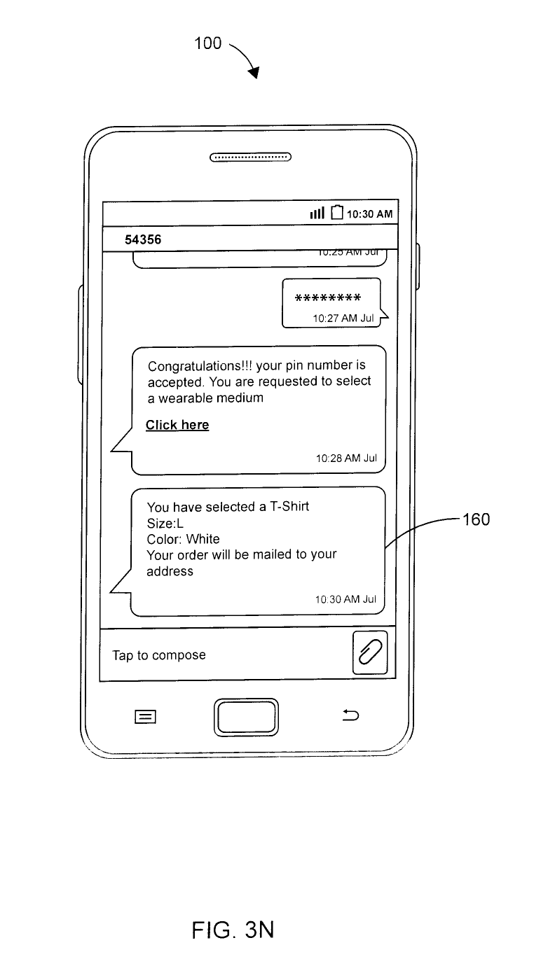

Another embodiment of the present invention can be seen in FIGS. 3A through 3M which show various steps 100 involved in selecting a desired communicated text message for inscribing a memorabilia on a wearable medium utilizing a mobile device employing a secret pin number. The mobile devices may include Blackberry, Android, i Phone, i Pad, tablets, windows and iOS platform devices. As shown in FIG. 3A, a user initiates a process by clicking on an application 102 and moves from a home page 104 into an application login page 106 as shown in FIG. 3B. The application login page 106 is configured to enter an E-mail id 108 and a password 110 and on clicking a login button 112, the user is allowed to login. The user can create a new account utilizing a button “Create an account” 114. With reference to FIG. 3C, the user is required to enter the name of user 116, address 118, cell number 120 and credit card number 122 for creating the user account. The user account gets activated by enabling the button “Activate my account” 124. When the user account is activated, the user receives a secret pin number by means of a selected mode of contact: email or cell number for example. FIG. 3D shows a list of received messages 126 and an option to create a new message 128. The user is able to select a desired option for messaging which includes: creating a message, retrieving a message from inbox and retrieving a message from outbox. FIG. 3E shows creating a new message 132 and sending the message 134 to a service provider 130. After receiving the message from the user, the service provider creates a file corresponding to the received message and match the created file with existing user account by considering cell number 120 as a validation point. Thereafter, the service provider 130 sends a verification message 136 to the user as shown in FIG. 3F. As shown in FIG. 3G the service provider 130 requests the user to confirm the order and to send the user's secret pin number. FIG. 3H shows sending the secret pin number 138 to the service provider 130. Next, with reference to FIG. 3I, another verification message 140 from the service provider 130 is illustrated FIG. 3J shows another verification message 140 from the service provider 130 requesting the user to select at least one wearable medium from the list of wearable medium. The user can select the at least one wearable medium utilizing a click here button 142. FIG. 3K shows the available wearable medium. The list of wearable medium may include T-Shirt 144, necklace 146 and bracelets 148. The user can select the desired color 150, size 152 and style 154 for the wearable medium. Finally, the user clicks on the ok button 156 to confirm the selection. FIG. 3L shows the T-Shirt 144 as the wearable medium selected by the user with color 150, and size 152. The user can press ok button 156 to send the message to the service provider and cancel button 158 to cancel the message. FIG. 3M shows the final message 160 from the service provider 130 confirming the final selection of the wearable medium. FIG. 3N shows a final verification message 160 from the service provider 130 informing the user about the delivery of the selected wearable medium with color and size. Inscribing a communicated text message as a wearable memorabilia may include etching, printing, stamping and engraving.

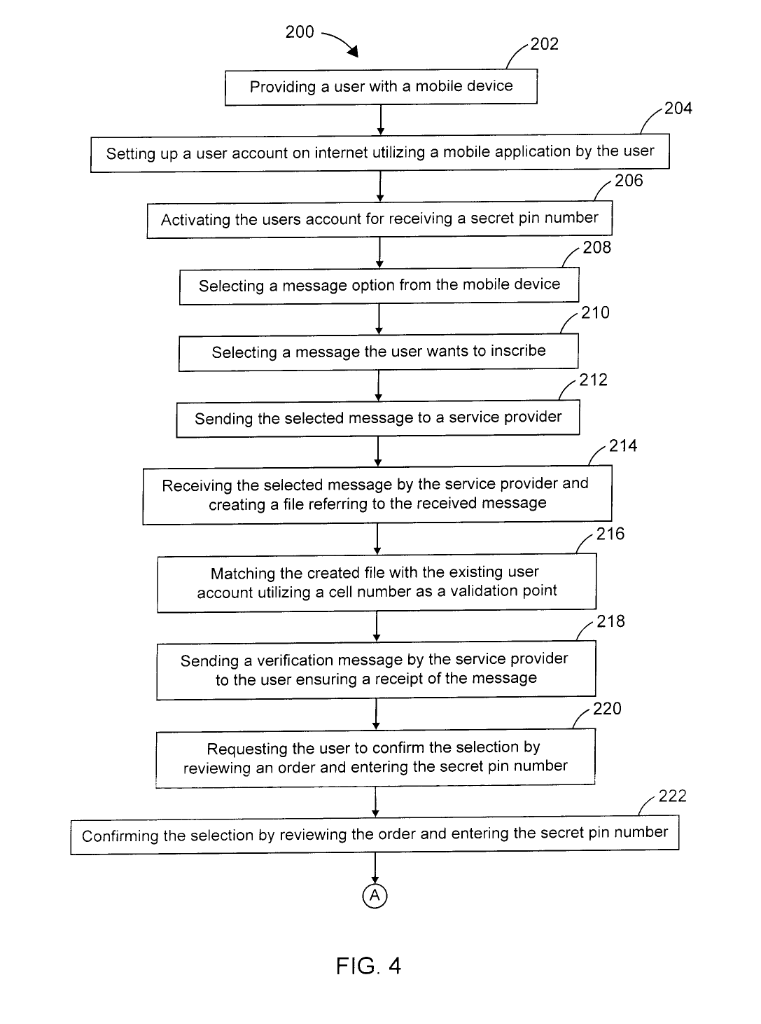

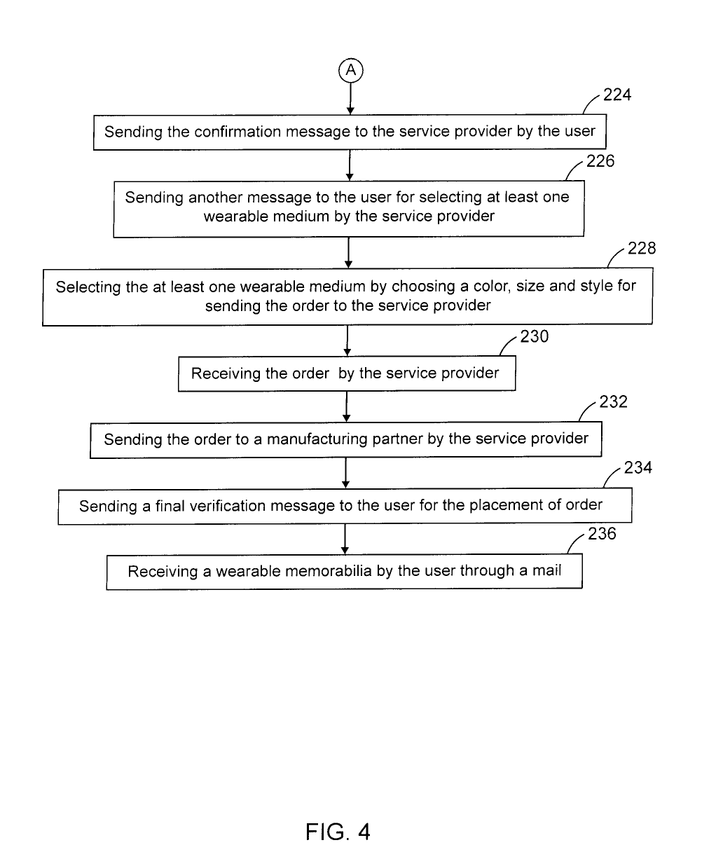

FIG. 4 is an operational flow chart illustrating a business method for inscribing the communicated text message as the wearable memorabilia utilizing the mobile device employing a secret pin number in accordance with one aspect of another embodiment of the present invention 200. As shown in block 202 the user is provided with a mobile device. The user sets up a user account on internet utilizing a mobile application as shown in block 204. The user gets a secret pin number when the account gets activated as shown in block 206. As indicated in block 208 the user selects a message option from the mobile device. The messaging option may include creating a message, retrieving a message from inbox and retrieving a message from outbox. The user selects a message from the message option for inscribing as shown in block 210. The user sends the selected message to a service provider as indicated in block 212. When the service provider receives the selected message, a file referring to the received message is created as shown in block 214. As indicated in block 216 the created file is matched with the existing user account utilizing the cell number as a validation point. Then the service provider sends a validation message to the user ensuring a receipt of the message as shown in block 218. The service provider requests the user to confirm the selection by reviewing an order and entering the secret pin number as shown in block 220. By reviewing the order and entering the secret pin number the user confirms the selection as shown in block 222. The user sends the confirmation message to the service provider as shown in block 224. The service provider sends another verification message to the user for selecting at least one wearable medium as shown in block 226. The list of wearable medium may include T-Shirts, necklaces and bracelets. The user selects the at least one wearable medium by choosing a color, size and style for sending the order to the service provider as shown in block 228 The service provider receives the order as a text message from the user as shown in block 230. The service provider sends the order to a manufacturing partner as shown in block 232. The service provider sends the final verification message to the user for confirming the placement of order as shown in block 234. The user receives the wearable memorabilia by mail or courier as shown in block 236. The payment for inscribing can be done through mobile bill or can be selected from a group consisting of credit card, debit card and the like.

While the inventive method refers to wearable memorabilia, it is understood that other products upon which etching, stamping, engraving, and printing is possible can also fall within the scope of the inventive method, e.g., jewelry, pens, plaques, trophies, etc.

What is claimed is:

1. A business method for inscribing a communicated text message as memorabilia utilizing a mobile device adaptable with a mobile application, the method comprising the steps of:
a) providing a user with the mobile device;
b) accessing the mobile application utilizing the mobile device;
c) authenticating the mobile application utilizing the mobile device;
d) user setting up a user account for sharing information with other users;
e) logging into the user's account by entering an email id and password;
f) selecting a text message the user wants to inscribe;
g) capturing an image of the text message for making a memorable item;
h) modifying and resizing the image of the selected text by the user;
i) confirming the selection and modification by the user;
j) selecting at least one memorable item for purchase;
k) selecting a color, size, or style for the memorable item;
l) sending the image with the memorable item to a service provider; and
m) mailing the memorable item to the user by the service provider.

2. The method of claim 1, wherein the memorable item is a wearable item.

3. The method of claim 1, wherein the memorable item is one that is capable of being etched, engraved, or printed upon, and mailed by a service provider.

4. The method of claim 1, wherein the mobile application is capable of converting the telephonic text message into memorabilia.

5. The method of claim 1, wherein the payment for inscribing can be made through mobile bill.

6. The method of claim 1, wherein the payment for inscribing can be made by credit card, charge card, debit card, or paypal.

7. The method of claim 1, wherein modification is done by cropping and resizing the image of the selected text.

8. The method of claim 1, wherein inscribing a communicated text message as a memorable item includes etching, printing, stamping and engraving.

9. A business method for inscribing a communicated text message as memorabilia utilizing a mobile device adaptable with a mobile application and having a secret pin number for safe transaction, the method comprising the steps of:
a) providing a user with the mobile device;
b) setting up a user account utilizing the mobile application by the user;
c) activating the user account for receiving the secret pin number;
d) selecting a message option from the mobile device;
e) selecting a message user wants to inscribe;
e) sending an order for the selected message to a service provider;
f) receiving the selected message by the service provider and creating a file referring to the received message;
g) matching the created file with the existing user account utilizing a cell number as a validation point;
h) sending a verification message by the service provider to the user for ensuring a receipt of the message;
i) requesting the user to confirm the selection by reviewing the order and entering the secret pin number;
i) confirming the selection by reviewing the order and entering the secret pin number;
j) sending a confirmation message to the service provider by the user;
k) sending a message to the user for selecting at least one memorable item from a given list;
l) selecting the at least one memorable item choosing a color, size or style for sending the order to the service provider;
m) receiving the order by the service provider;
n) sending the order to a manufacturing partner by the service provider;
o) sending the message to the user by the service provider confirming the placement of order; and
p) receiving the memorable item by the user by mail or courier.

10. The method of claim 9, wherein the memorable item is a wearable item.

11. The method of claim 9 wherein the memorable item is one that is capable of being etched, engraved, stamped, or printed upon, and mailed by a service provider.

12. The method of claim 9 wherein the user account includes information such as name, address, cell number, credit card information and the like.

13. The method of claim 9 wherein the messaging option includes creating a message, retrieving a message from inbox and retrieving a message from outbox.

14. The method of claim 9 wherein the messaging service is Short Message Service (SMS).

15. The method of claim 9 wherein the messaging service is Multimedia Messaging Service (MMS).

16. The method of claim 9, wherein modes for inscribing a communicated text message as a wearable memorabilia includes etching, printing, stamping and engraving.

17. The method of claim 9, wherein payment for inscribing can be made through mobile bill.

18. The method of claim 1, wherein the payment for inscribing can be made by credit card, charge card, debit card, or paypal.
